(19) United States
(12) Patent Application Publication
(10) Pub. No.: US 2022/0347881 A1
(43) Pub. Date: Nov. 3, 2022

(54) TABLE SAW ATTACHABLE STORAGE DEVICE

(71) Applicant: Larry Bowman, Rockwood, TN (US)

(72) Inventor: Larry Bowman, Rockwood, TN (US)

(21) Appl. No.: 17/727,923

(22) Filed: Apr. 25, 2022

Related U.S. Application Data
(60) Provisional application No. 63/181,546, filed on Apr. 29, 2021.

(51) Int. Cl. B27B 5/29; B43L 23/00

(52) U.S. Cl. CPC B27B 5/29; B43L 23/00

(57) ABSTRACT

The present invention relates generally to the field of table saws. More specifically, the present invention relates to a table saw attachable storage device primarily comprised of a body further comprised of an interior cavity that can receive and store a table saw fence. In differing embodiments, the body may magnetically attach to a table saw cutting surface in a variety of locations or attach via at least one fastener and a mounting bracket. The body may further be comprised of a pencil retaining compartment further comprised of a pencil sharpener. In addition, the device may be comprised of at least one end cap to prevent sawdust from entering into the body when not in use.

### CROSS-REFERENCE TO RELATED APPLICATION

The present application claims priority to, and the benefit of, U.S. Provisional Application No. 63/181,546 which was filed on Apr. 29, 2021, and is incorporated herein by reference in its entirety.

### FIELD OF THE INVENTION

The present invention relates generally to the field of table saws. More specifically, the present invention relates to a table saw attachable storage device primarily comprised of a body further comprised of an interior cavity that can receive and store a table saw fence. In differing embodiments, the body may magnetically attach to a table saw cutting surface in a variety of locations or attach via at least one fastener and a mounting bracket. The body may further be comprised of a pencil retaining compartment further comprised of a pencil sharpener. In addition, the device may be comprised of at least one end cap to prevent sawdust from entering into the body when not in use. Accordingly, the present disclosure makes specific reference thereto. Nonetheless, it is to be appreciated that aspects of the present invention are also equally applicable to other like applications, devices and methods of manufacture.

### BACKGROUND

A table saw fence (e.g., a rip fence) is used to keep material in place as a rip cut is made along the grain of said material. However, table saw fences are not often used when not making rip cuts. As a result, the fence is typically removed from the table saw. However, if a user is making a plurality of differing cuts, they may have to repeatedly remove and reinstall the fence when it is needed to make various cuts. Yet, existing table saws known in the art lack an area to store a rip fence when not in use. As a result, a user must store a rip fence in a nearby area close to the table saw or even under or around the floor surface of a table saw. This is undesirable and potentially dangerous, as the fence may fall or be tripped over, such that the table saw can cause serious injury to the user.

Therefore, there exists a long-felt need in the art for an improved location to store a table saw fence. There also exists a long-felt need in the art for a table saw attachable storage device that can be easily and removably installed to a table saw. Further, there exists a long-felt need in the art for a for a table saw attachable storage device that can be easily and removably installed to a table saw, wherein the device allows a table saw fence to be stored in an area that is easily accessible and non-hazardous to a table saw user.

The subject matter disclosed and claimed herein, in one embodiment thereof, comprises a table saw attachable storage device. The device is primarily comprised of a body further comprised of an interior cavity that can receive and store a table saw fence. In differing embodiments, the body may magnetically attach to a table saw cutting surface in a variety of locations or attach via at least one fastener and a mounting bracket. The body may further be comprised of a pencil retaining compartment further comprised of a pencil sharpener. In addition, the device may be comprised of at least one end cap to prevent sawdust from entering into the body when not in use.

In this manner, the table saw attachable storage device of the present invention accomplishes all of the foregoing objectives and provides an improved location to store a table saw fence. Further, the device can be easily and removably installed to a table saw. In doing so, the device remains easily accessible and non-hazardous to a table saw user.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a table saw attachable storage device. The device is primarily comprised of a body further comprised of an interior cavity that can receive and store a table saw fence. In differing embodiments, the body may be manufactured from a durable metal or a rigid plastic. In an embodiment wherein the body is made of a durable metal, said material may be magnetic or have a magnetized coating.

The body is generally rectangular shaped in the preferred embodiment and has a top wall, a pair of side walls, and a bottom wall that form an interior cavity made by the interior surfaces of each wall. The body is opened ended on its first end and second end such that it can receive any length of table saw fence without limitation. In one embodiment, the interior surfaces of the cavity are comprised of at least one magnet such that a table saw fence stored within the body cannot inadvertently be knocked out or fall out of the device, thereby avoiding the possibility of creating a tripping hazard or potential injury while operating a table saw the device is attached to.

In one embodiment of the device with a magnetized body, the top wall can magnetically attach to the bottom surface of the cutting surface of a table saw. In a non-magnetic embodiment of the body, the top wall, side wall, or bottom wall may be comprised of at least one fastener such as, but not limited to: a hook and loop fastener, adhesive, etc. that allows the body to attach to the bottom surface of the cutting surface of a table saw. In a differing embodiment, the device may also be comprised of a mounting bracket with at least one continuous opening that corresponds with a continuous opening on the top wall of the body. In this manner, at least one fastener can be placed through both openings such that the mounting bracket can be secured to the body through the cutting surface of the table saw.

The device may also be comprised of at least one pencil retaining compartment located on a wall of the body. The compartment can further store at least one carpenter pencil. In addition, the outer surface of the compartment may further be comprised of at least one pencil sharpener that can be used to sharpen a carpenter pencil. At least one magnetic or non-magnetic end cap may also be used to cover the continuous openings of the first end and second end of the body. In this manner, when the contents of the device need not be accessed or the device need not be used, sawdust cannot enter the interior cavity.

Accordingly, the table saw attachable storage device of the present invention is particularly advantageous as it provides an improved location to store a table saw fence that can be easily and removably installed to a table saw. Further, the device remains easily accessible and non-hazardous to a table saw user. In this manner, the table saw attachable storage device overcomes the limitations of existing methods of storing table saw fences known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a table saw attachable storage device of the present invention in accordance with the disclosed architecture;

FIG. 2 illustrates a perspective view of one potential embodiment of a table saw attachable storage device of the present invention while attached to a table saw in accordance with the disclosed architecture; and

FIG. 3 illustrates a perspective view of one potential embodiment of a table saw attachable storage device of the present invention while attached to a table saw in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved location to store a table saw fence. There also exists a long-felt need in the art for a table saw attachable storage device that can be easily and removably installed to a table saw. Further, there exists a long-felt need in the art for a for a table saw attachable storage device that can be easily and removably installed to a table saw, wherein the device allows a table saw fence to be stored in an area that is easily accessible and non-hazardous to a table saw user.

The present invention, in one exemplary embodiment, is comprised of a table saw attachable storage device primarily comprised of a body further comprised of an interior cavity that can receive and store a table saw fence. In differing embodiments, the body may be manufactured from a durable metal or a rigid plastic. In an embodiment wherein the body is made of a durable metal, said material may be magnetic or have a magnetized coating.

Furthermore, the body is preferably generally rectangular shaped in the preferred embodiment. In said embodiment, the body has a top wall, a pair of side walls, and a bottom wall that form an interior cavity made by the interior surfaces of each wall. The body is opened ended on its first end and second end such that it can receive any length of table saw fence without limitation. In one embodiment, the interior surfaces of the cavity are comprised of at least one magnet such that a table saw fence stored within the body cannot inadvertently be knocked out or fall out of the device, thereby avoiding the possibility of creating a tripping hazard or potential injury while operating a table saw the device is attached to.

In an embodiment of the device with a magnetized body, the top wall can magnetically attached to the bottom surface of the cutting surface of a table saw. In a non-magnetic embodiment of the body, the top wall, side wall, or bottom wall may be comprised of at least one fastener such as, but not limited to: a hook and loop fastener, adhesive, etc. that allows the body to attach to the bottom surface of the cutting surface of a table saw. In a differing embodiment, the device may also be comprised of a mounting bracket with at least one continuous opening that corresponds with a continuous opening on the top wall of the body. In this manner, at least one fastener can be placed through both openings such that the mounting bracket can be secured to the body through the cutting surface of the table saw.

The device may also be comprised of at least one pencil retaining compartment located on a wall of the body which can store at least one carpenter pencil. In addition, the outer surface of the compartment may further be comprised of at least one pencil sharpener that can be used to sharpen a carpenter pencil. At least one magnetic or non-magnetic end cap may also be used to cover the continuous openings of the first end and second end of the body. In this manner, when the contents of the device need not be accessed or the device need not be used, sawdust cannot enter the interior cavity.

Accordingly, the table saw attachable storage device of the present invention is particularly advantageous as it provides an improved location to store a table saw fence that can be easily and removably installed to a table saw. Further, the device remains easily accessible and non-hazardous to a table saw user. In this manner, the table saw attachable storage device overcomes the limitations of existing methods of storing table saw fences known in the art.

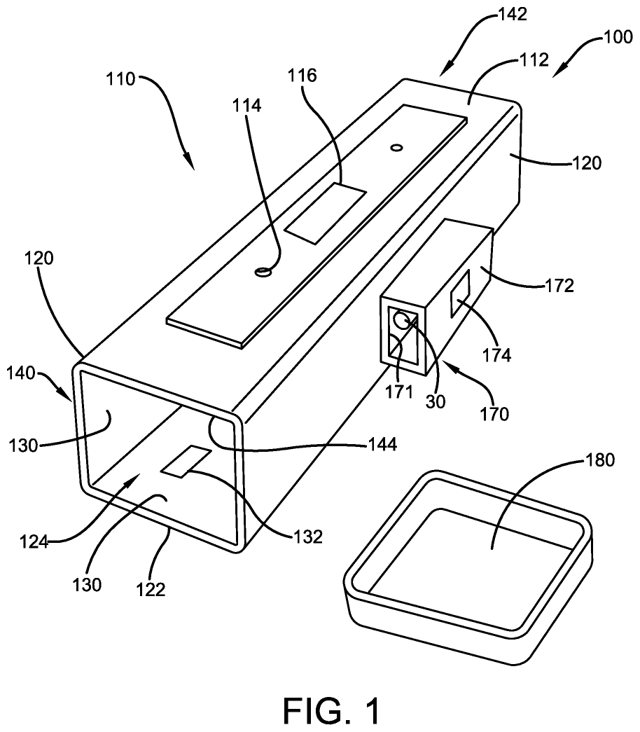

Referring initially to the drawings, FIG. 1 illustrates a perspective view of one potential embodiment of a table saw attachable storage device 100 of the present invention in accordance with the disclosed architecture. The device 100 is primarily comprised of a body 110 further comprised of an interior cavity 124 that can receive and store a table saw fence 20. In differing embodiments, the body 110 may be manufactured from a plurality of material. Said material may be a durable metal such as, but not limited to: stainless steel or aluminum, or a rigid plastic such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. In an embodiment wherein the body 110 is made of a durable metal, said material may be magnetic or have a magnetized coating.

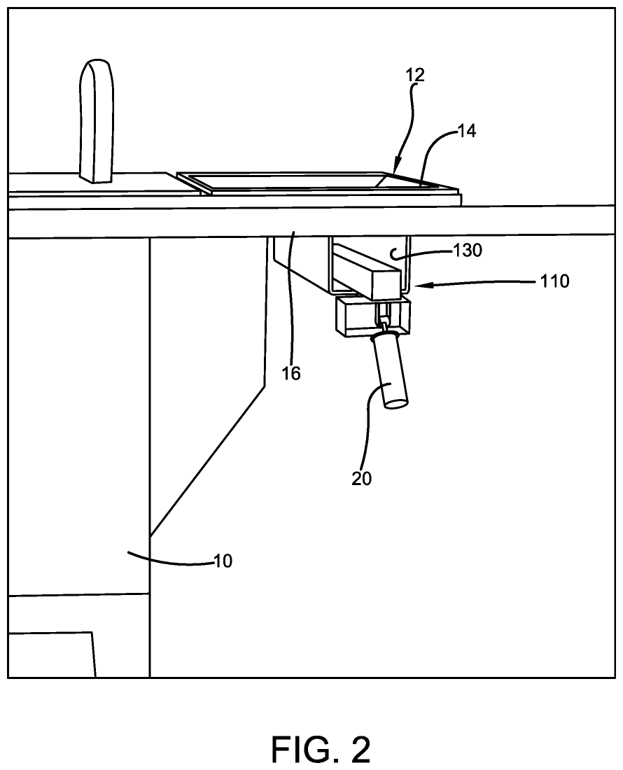

The body 110 is generally rectangular shaped in the preferred embodiment. However, in differing embodiments, the body 110 may be any shape known in the art such as, but not limited: square, triangular, circular, cylindrical, etc. In the preferred rectangular embodiment, the body 110 has a top wall 112, a pair of side walls 120, and a bottom wall 122. Together, the walls 112,120,122 form an interior cavity 124 made by the interior surfaces 130 of each wall 112,120,122. The body 110 is opened ended on its first end 140 and second end 142 such that it can receive any length of table saw fence 20 without limitation, as seen in FIG. 2. Additionally, a plurality of objects such as, but not limited to: push sticks, tape measures, wood stock, etc. can be stored within the interior cavity 124. In one embodiment, the interior surfaces 130 of the cavity 124 are comprised of at least one magnet 132 (or may be inherently magnetized due to the metal material of the body 110). The magnet 132 may be positioned in any location on the interior surfaces 130 such that it may magnetically retain a table saw fence 20. In this manner, the fence 20 cannot inadvertently be knocked out or fall out of the device 100, thereby avoiding the possibility of creating a tripping hazard or potential injury while operating a table saw 10 the device 100 is attached to.

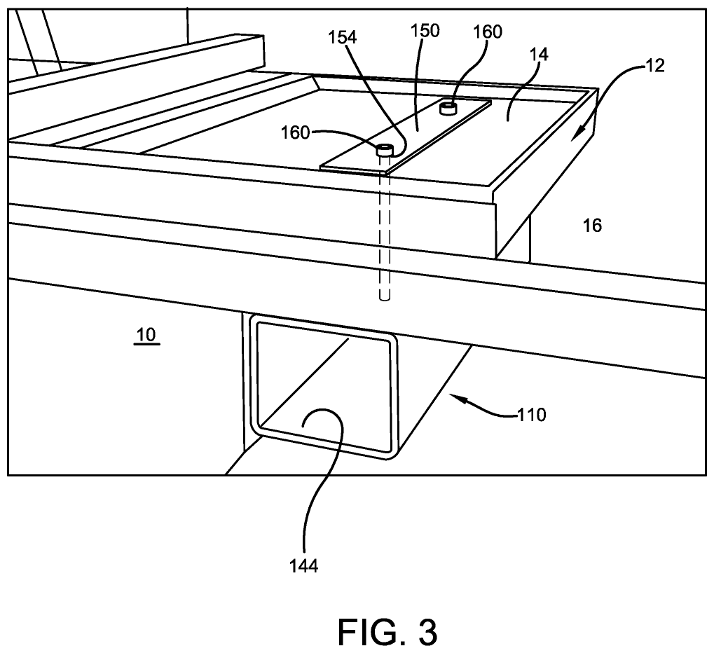

In one embodiment of the device 100 with a magnetized body 110, the top wall 112 can magnetically attach to the bottom surface 16 of the cutting surface 12 of a table saw 10. In a non-magnetic embodiment of the body 110, the top wall 112, side wall 120, or bottom wall 122 may be comprised of at least one fastener 116 such as, but not limited to: a hook and loop fastener, adhesive, etc. that allows the body 110 to attach to the bottom surface 16 of the cutting surface 12 of a table saw 10. In a differing embodiment, the device 100 may also be comprised of a mounting bracket 150, as seen in FIG. 3. The mounting bracket 150 may be manufactured from the same material as the body 110 and is preferably rectangular in shape. The top surface 152 of the bracket 150 is primarily comprised of at least one continuous opening 154. Said opening 154 preferably corresponds with a continuous opening 114 on the top wall 112 of the body 110. In this manner, at least one fastener 160 can be placed through both openings 114,154 such that the mounting bracket 150 (placed on the top surface 14 of the cutting surface 12 of a table saw 10) can be secured to the body 110 (placed on the bottom surface 16 of the cutting surface 12 of a table 10) through the cutting surface 12. In differing embodiments, the fastener 160 may be any fastener known in the art such as, but not limited to: screw, bolt, bolt/nut/washer assembly, etc. As a result, the device 100 can be removably secured to a table saw 10.

It should be noted that due to the various embodiments and various attachment methods, the device 100 is extremely versatile and can be positioned on nearly any surface or position on a table saw 10. In this manner, a user can customize the position of the device 100 to best suit their needs and work space availability.

The device 100 may also be comprised of at least one pencil retaining compartment 170 located on a wall 112,120, 122 of the body 110. The compartment 170 may be the same general shape as the body 110 and is preferably fixedly attached to the body 110. The compartment 170 has at least one opening 171 and can further store at least one carpenter pencil 30. In addition, the outer surface 172 of the compartment 170 may further be comprised of at least one pencil sharpener 174 that can be used to sharpen a carpenter pencil 30.

At least one magnetic or non-magnetic end cap 180 may also be used to cover the continuous openings 144 of the first end 140 and second end 142 of the body 110. In this manner, when the contents of the device 100 need not be accessed or the device need not be used, sawdust cannot enter the interior cavity 124.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “table saw attachable storage device” and “device” are interchangeable and refer to the table saw attachable storage device 100 of the present invention.

Notwithstanding the foregoing, the table saw attachable storage device 100 of the present invention and its various components can be of any suitable size and configuration as is known in the art without affecting the overall concept of the invention, provided that they accomplish the above-stated objectives. One of ordinary skill in the art will appreciate that the size, configuration and material of the table saw attachable storage device 100 as shown in the FIGS. are for illustrative purposes only, and that many other sizes and shapes of the table saw attachable storage device 100 are well within the scope of the present disclosure. Although the dimensions of the table saw attachable storage device 100 are important design parameters for user convenience, the table saw attachable storage device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A table saw attachable storage device comprising:
a body having an interior cavity;
a pencil retaining compartment further comprised of a pencil sharpener and a continuous opening; and
an end cap.

2. The table saw attachable storage device of claim 1 further comprising a mounting plate.

3. The table saw attachable storage device of claim 2, wherein the mounting plate attaches to the body.

4. A table saw attachable storage device comprising:
a magnetic body having an interior cavity;
a pencil retaining compartment;
a pencil sharpener;
a continuous opening; and
an end cap.

5. The table saw attachable storage device of claim 4, wherein the magnetic body is generally rectangular in shape.

6. The table saw attachable storage device of claim 5, wherein the magnetic body is further comprised of a top wall having an interior surface.

7. The table saw attachable storage device of claim 5, wherein the magnetic body is further comprised of a pair of side walls each having an interior surface.

8. The table saw attachable storage device of claim 7, wherein each interior surface of the pair of side walls is magnetic.

9. The table saw attachable storage device of claim 5, wherein the magnetic body is further comprised of a bottom wall having an interior surface.

10. The table saw attachable storage device of claim 4, wherein the end cap attaches over the continuous opening of the magnetic body.

11. A table saw attachable storage device comprising:
a body having an interior cavity;
a pencil retaining compartment comprised of a pencil sharpener, a first end with a continuous opening, and a second end with a continuous opening;
an end cap;
a mounting bracket comprised of a continuous opening; and
a fastener.

12. The table saw attachable storage device of claim 11, wherein the mounting bracket attaches to the body via the fastener.

13. The table saw attachable storage device of claim 12, wherein the fastener is a bolt.

14. The table saw attachable storage device of claim 11, wherein a magnet is positioned in the interior cavity.

15. The table saw attachable storage device of claim 11, wherein the pencil sharpener is located on an outer surface of the pencil retaining compartment.

16. The table saw attachable storage device of claim 11, wherein the body is rectangular in shape.

17. The table saw attachable storage device of claim 16, wherein the body is comprised of a top wall having an interior surface, a pair of side walls each having an interior surface, and a bottom wall having an interior surface.

18. The table saw attachable storage device of claim 17, wherein the fastener is positioned on at least one of the top wall, the pair of side walls, and the bottom wall.

19. The table saw attachable storage device of claim 18, wherein the fastener is a magnet fastener, a hook and loop fastener or an adhesive fastener.

20. The table saw attachable storage device of claim 11, wherein the body is comprised of a magnetic material.
